(19) United States
(12) Patent Application Publication
(10) Pub. No.: US 2009/0038119 A1
(43) Pub. Date: Feb. 12, 2009

(54) FRICTION HINGE WITHOUT APPLIED GREASE

(76) Inventors: Edward Rude, Columbia, MD (US); Walter Brokowski, Stamford, CT (US); Robert Mozdzer, Stamford, CT (US)

Correspondence Address: GOTTLIEB RACKMAN & REISMAN PC, 270 MADISON AVENUE, 8TH FLOOR, NEW YORK, NY, 10016-0601, US

(21) Appl. No.: 12/187,447

(22) Filed: Aug. 7, 2008

Related U.S. Application Data
(60) Provisional application No. 60/954,350, filed on Aug. 7, 2007.

(51) Int. Cl. E05D 11/08

(52) U.S. Cl. 16/342

(57) ABSTRACT

A friction hinge uses a plastic frictional member operating against a metal shaft that needs no topically applied grease, can achieve long cycle life and can be sealed against external contamination. The frictional member engages the shaft of the hinge to form a frictional engagement to permit rotation only while a torque is applied on the housing or the shaft. For this purpose the frictional member is made initially with a smaller diameter then the shaft and is then crushed or deformed as the shaft is inserted into the frictional member. Spaces are provided about the shaft to receive material as the element is being deformed.

### RELATED APPLICATIONS

This application claims priority to provisional application Ser. No. 60/954,350 filed Aug. 7, 2007 incorporated herein by reference.

### BACKGROUND TO THE INVENTION

A. Field of Invention

This invention pertains to a hinge used to couple two parts in a manner that allows mutual rotation therebetween in response to a torque, wherein the hinge includes a sleeve attached to one part and a shaft attached to another part. A frictional member is disposed between the sleeve and the shaft. This element is made of a plastic material. The element is sized and shaped to plastically deform during assembly to provide an interference fit with the shaft. Importantly, no grease or other lubricant is applied in the interference fit.

B. Description of the Prior Art

Most prior art friction hinges have used steel parts bearing against a steel shaft to produce the requisite friction in a small envelope. The steel-on-steel methodology produces marginally acceptable torque levels and working life only if grease is used at the interface. These hinges are expensive to manufacture because they require close tolerances, careful heat-treatment processes, and manual cleaning following application of the grease. Friction hinges of this type suffer from leakage of the lubricant which can damage the sensitive equipment in which they are used. Also, because they are usually not sealed, these hinges deteriorate when dirt, dust, or other contaminants from outside find their way into the frictional interface. In principle, sealing such hinges is possible, but cost and space limitations usually preclude doing that.

Some hinges have been made by pressing a steel shaft into a solid plastic body. This works reasonably well, given an appropriate choice for the plastic material. But manufacture is difficult because the elastic properties of plastics requires very close dimensional tolerances to control the torque. This is expensive and problematic for molded plastic parts.

### SUMMARY OF THE INVENTION

Our invention provides a friction hinge using a steel shaft and molded plastic parts whose tolerances requirements are within the normal range for such manufacture. In addition, the hinge of our invention does not require the application of grease, can be sealed against outside contaminants, and exhibits extremely long life under typical conditions of use.

The new hinge is comprised of a steel shaft that can rotate within a housing that is either made entirely of plastic or which has plastic interior surfaces. The steel shaft is sized and shaped to for an interference fit in the housing. During assembly a certain degree of failure of the plastic takes place that generates or contributes to the interference fit. The housing is designed with free space that accommodates the plastic material displaced during the failure. Without the space for the displaced or distorted plastic material to occupy, as is the case in plastic friction hinges of the prior art, the entire inner cylindrical surface of plastic has to expand in order for the shaft to enter the housing. In this case the hoop stress for a given amount of interference is much larger than if only local displacement of plastic material takes place. In prior art plastic hinges, the force required to insert the shaft, and the resulting frictional torque needed to rotate the shaft within the housing varies rapidly with the amount of initial interference between the shaft's diameter and that of the hole in the housing. The shaft size is easy to control in manufacture. But controlling the torque under those conditions requires very exacting dimensional control over the hole diameter as well. Not only is this difficult to do economically, but very slight amounts of wear will cause large reductions in torque. In a molded part of the size needed for the housings of our hinges, up to an inch or so in diameter, molders can be expected to maintain the inside diameter within a tolerance range of ±0.001 inches. And the outside diameter of the shaft may be as much as 0.010 inches larger than the hole in the molded part, giving a starting interference, before the insertion of the shaft, in the range of 0.008 to 0.012 inches depending upon the torque required. If, as in some friction hinges of the prior art, a shaft is inserted into such a solid cylindrical plastic housing, the initial hole diameter would have to be held to a tolerance about ten times as close as compared to the present invention. This requires secondary machining of the molded plastic and, even then, it is difficult to achieve and maintain. The present invention enables a relatively inexpensive manufacturing process for both the housing and the shaft.

Additionally, in the preferred embodiments of the invention, the interfering plastic is can be made up of multiple, identical elements whose number can be chosen to provide a range of torque values for the assembled hinge without having to alter parts or fabricate new ones.

The plastic hinge presented herein can be used without lubrication. Alternatively, a plastic material with entrapped lubricant may be used, and the resulting hinge exhibits very good, long-life operation while never releasing a sufficient quantity of lubricant to appear on the exterior of the hinge.

It is an object of the invention to provide a friction hinge having the capability of maintaining very constant torque over a long cycle life.

It is another object of the invention to provide a friction hinge that does not require the addition of topical lubrication at the frictional interface.

It is yet a further object of the invention to provide a friction hinge for use in environments that are sensitive to contamination.

It is a still further object of the invention to provide a friction hinge that is well protected from dust, dirt, and other external contaminants.

It is another object of the invention to provide an accurate friction hinge requiring a torque within a predetermined range for operation that can manufactured inexpensively.

Yet another objective is to provide a friction hinge having the above mentioned benefits in a small package.

The inventive friction hinge accordingly comprises the features of construction, combination of elements, and arrangement of parts which will be exemplified in the constructions described hereinafter, and the scope of the invention will be indicated in the claims.

### BRIEF DESCRIPTION OF THE DRAWINGS

FIG. 1 is an external view of a preferred embodiment of the friction hinge of our invention with a mountable housing and a shaft with holes, each for attachment to the respective elements requiring a rotatable connection with predictable and reliable torque characteristics.

FIG. 2 is a perspective view of the housing of the hinge of FIG. 1 but with the shaft removed to show the frictional members within.

FIG. 3 is a cut-away view of the housing and friction producing elements of FIG. 2.

FIG. 4(a) shows a sectional view of the frictional member of FIGS. 1-3 before assembly;

FIG. 4(b) shows a sectional view of the frictional member of FIGS. 1-3 after assembly;

FIGS. 4(c) shows an end view of the friction element for the hinge of FIGS. 1-3;

FIGS. 5(a) and 5(b) show an end view and a longitudinal sectional view of an an alternative embodiment of the hinge of FIGS. 1-4 having fewer frictional members;

FIG. 6 is a cross-sectional view of a further embodiment of the hinge of FIGS. 1-4 having frictional members that are circular in their cross-sectional shape rather than trapezoidal as in the earlier embodiment.

FIG. 7 is a cross-sectional view of the hinge of FIG. 6 in which the elements have been distorted as a result of the insertion of an appropriate shaft.

FIG. 8 shows an alternative construction for the hinge of FIGS. 1-4 made either in a single molded part with a living hinge or from two nearly identical parts or halves that are assembled and held together within an appropriate housing;

FIG. 9 illustrates an orthogonal view of a still further embodiment in which the frictional member is integral with the housing;

FIG. 10 illustrates an exploded perspective view of another embodiment of the invention in which a molded housing has a beam which is deflected when the housing receives the shaft;

FIG. 11 depicts an exploded perspective view of a modification to the hinge of FIG. 10 in which the shaft has an axial flat surface so as to provide a detent when that surface contacts the internal beam in the housing.

FIG. 12 illustrates a perspective view of another embodiment in which the frictional member is an insert;

FIG. 13 is a depiction of the hinge of FIG. 12 but with segmented frictional members to permit easier variations in the torque; and

FIG. 14 is a perspective view of an embodiment of our invention in which the pressure of the plastic frictional member against the shaft is maintained by an external steel band, thereby permitting the plastic element to have a thinner wall without exceeding its limitation for elastic expansion as the shaft is inserted.

### DETAILED DESCRIPTION OF THE INVENTION

The present invention pertains to a friction hinge used for providing a rotational coupling between two parts. More particularly, as used herein and as is known in the industry, a friction hinge is a hinge that provides a frictional engagement between two parts so that the two parts will not rotate freely, but once positioned at a certain angle, will stay in that position until a torque is applied to one part or the other to increase or decrease the angle. A typical practical application for such a hinge is between the display and the keyboard of a laptop computer. Once the display is opened, it is desirable that the user be able to position the two parts at any angle without fearing that the display will either fully close or fully open once it is released.

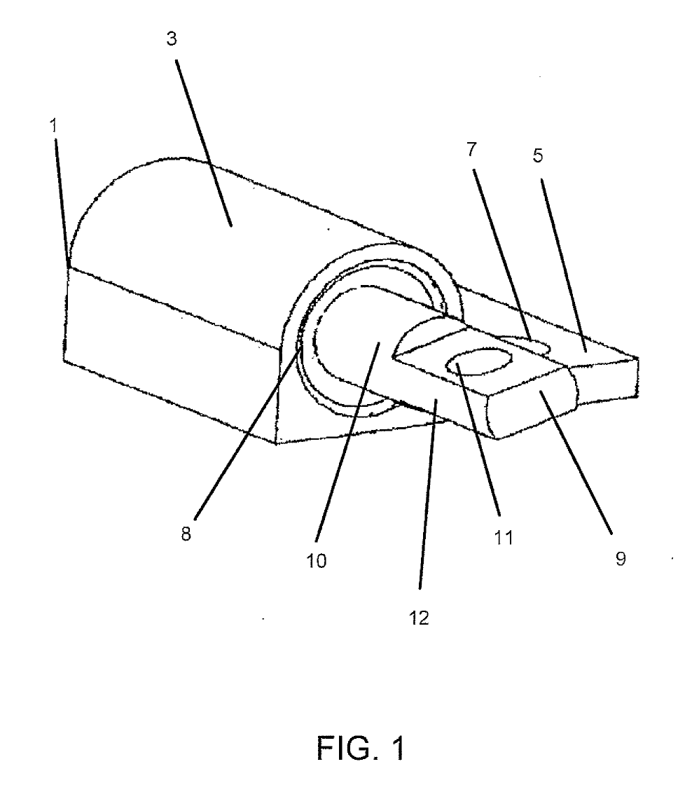

The friction hinge 1, whose exterior view is depicted in FIGS. 1-3, is similar to other friction hinges made today. Such a fringe is used to attach two elements which are to rotate with respect to one another and whose relative rotational movement is to require the application of a certain torque by the user. Housing or sleeve (3) contains the working mechanism of the friction hinge, and has mounting flange 5 as a part thereof for attachment to one of the two elements to be hinged together. Flange 5 has mounting holes 7. The detailed shape of flange 5 and the arrangement and sizes of the mounting holes can be made to suit the application. Shaft 9 is configured to accept attachment of the other element to be hinged. A frictional member 8 is positioned between the outer surface of shaft 9 and the inner surface of housing 3. Hole 11 is shown merely as an example of how the shaft can be attached to other elements or parts. The size, shape and position of the hole 11 can be made to suit the need.

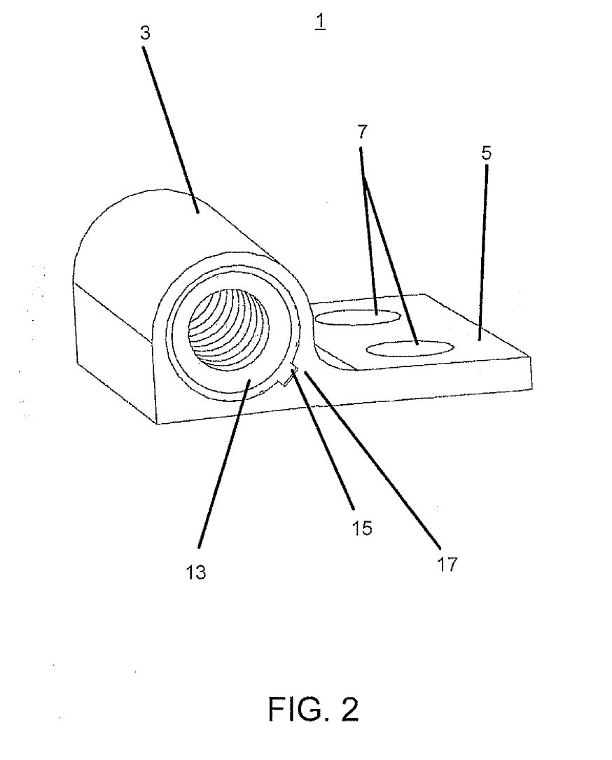

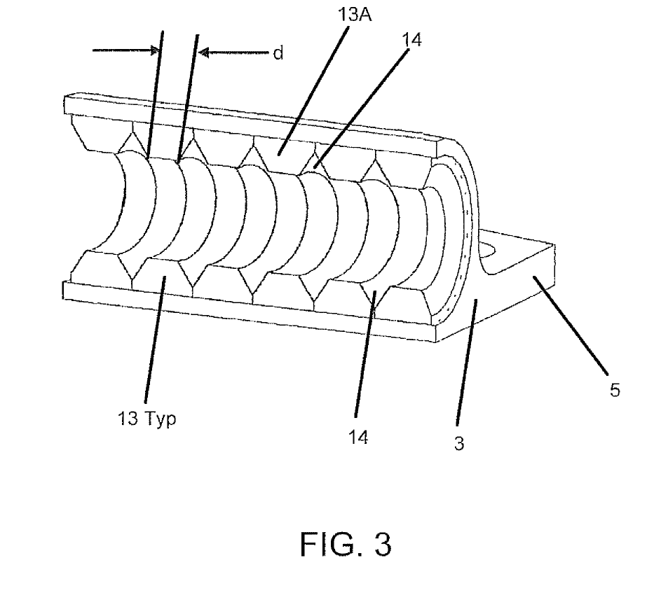

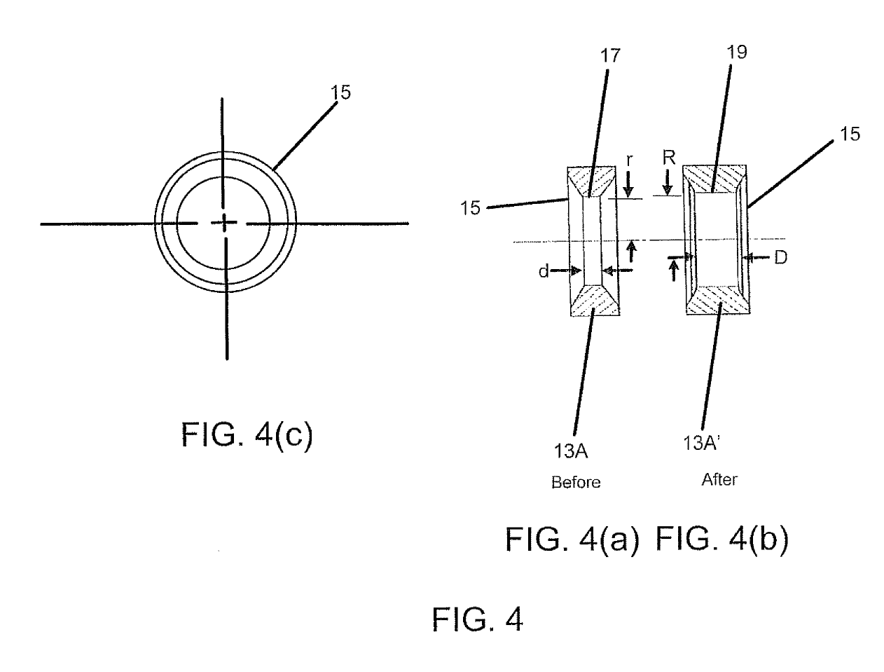

The preferred embodiment of our hinge, is shown in FIGS. 2 and 3 with shaft 9 removed to reveal interior elements of the hinge. The frictional member 8 consists of a stack of molded plastic disks 13 that fit snugly into housing 3. During assembly, shaft 9 is forced into the holes of the stack of disks 13. In FIG. 4(c) a single disk 15 is shown in elevation, and in FIG. 4(a) the cross-sectional shape 17 of a single disk 13 is shown before assembly. As can be seen in this figure, the disk 13 has trapezoidal shape with an inner radius and a minimum axial thickness d. FIG. 4 (b) shows how disk 13′ has been distorted so that it has a shape 19 as it would be after the shaft 9 has been inserted. In FIG. 4(b) the disk 13′ is shown as having a generally trapezoidal cross-section, it being understood that its exact shape may be somewhat indeterminate. However, its inner diameter will be equal to the diameter R of the shaft 9 and its axial thickness will increase to D.

Although they may not always be needed, disks 13 have been shown in FIG. 2 with molded anti-rotation keys 15 that fit into keyway 17 in housing 3, to prevent the disks from rotating within the housing as the shaft rotates. In some applications these features may not be necessary and have been omitted in FIGS. 4 and 4(a)-4(c).

One important feature of the hinge of FIGS. 1-4 is that the torque can be varied without the need to mold different disks or machine different shaft sizes. This can be accomplished by varying the number of disks 13 in the stack. If the full number of disks is not to be used, it may be desirable for some applications to use a filler between disks so as to maintain the spacing between the disks at the ends of the stack since these end disks act as bearings to keep the shaft coaxial with the housing.

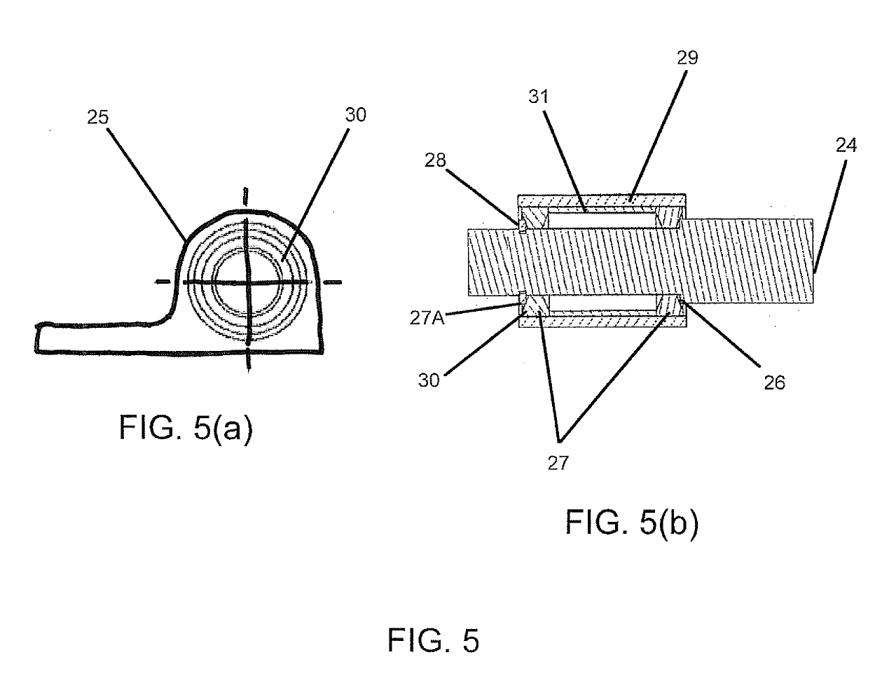

FIGS. 5(a) and 5(b) show a hinge 25 of the same type as the one in FIGS. 1-4 but with a frictional member 30 only two disks 27 inside housing 29 and a spacer 31 provided to maintain the spacing between the discs 27. In this embodiment, shaft 24 is formed with a shoulder 26 to form a stop for the hinge 25, and a groove 28 at the end. A split ring 30 fits into the groove 28 and is provided to make sure that the hinge does not migrate on the shaft axially during use.

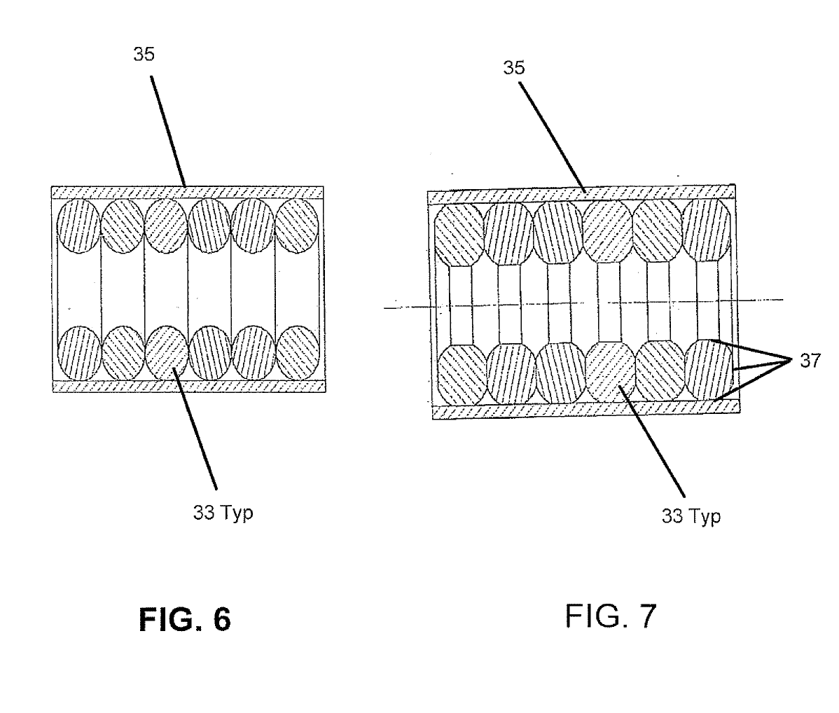

FIG. 6 is a cross-sectional elevation view of a hinge of the same type as the hinges discussed above except that the individual disks 33 in this hinge have a toroidal shape with circular cross-sectional shape rather than being rhombic as in the hinges of FIGS. 1-5. The important consideration here is that there is space available between the rings into which the material of the disks is displaced and flow upon insertion of the shaft, can move without requiring the enlargement of the overall exterior envelope of the housing. FIG. 7 shows, in a general way, how disks 33 may be shaped after a shaft is forced into the hinge. Disk surfaces 37 have been flattened against the shaft, against one another, and against the interior wall of housing 35.

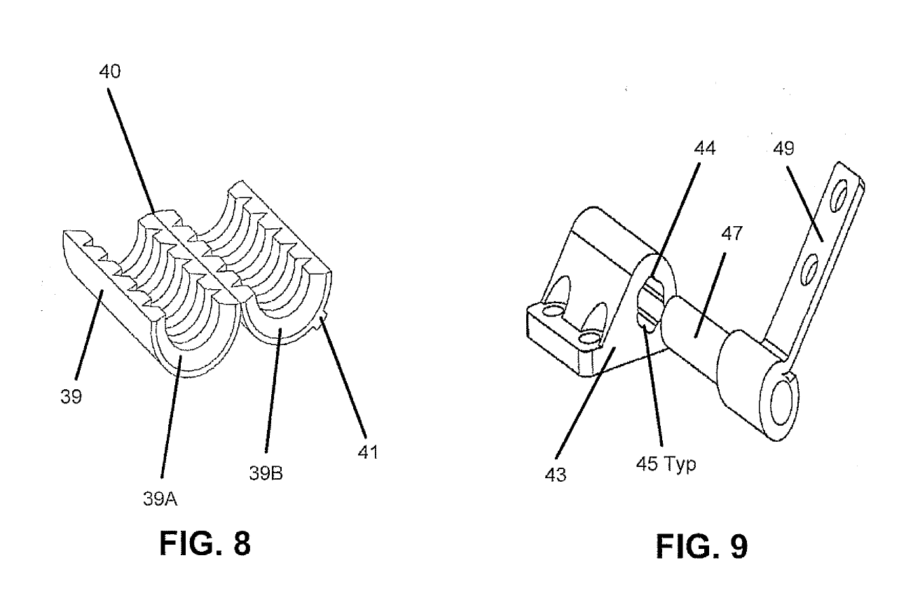

The embodiments illustrated so far include a frictional member formed of a stack of individual rings arranged coaxially. These disks have to be inserted into the sleeve of the hinge housing individually. This can be accomplished either by hand, or using a machine. However it is possible to mold the entire stack of disks as a single integral assembly 39 as shown in FIG. 8. The assembly 39 includes disk sections 39A and 39B joined by a live hinge 40. The stack assembly 39 requires only that it be folded along the live hinge and inserted into a housing such as housing 3. Set of ring sections 39 B are formed with a tab defining a key 41 that fits in a keyway of the housing ( similar to the arrangement in FIG. 2) to prevent the frictional member from rotating within the housing. If no key is needed, then the two halves of the assembly could be identical and they could be molded as one piece. Alternatively, the two halves of the assembly could be molded separately and then inserted into a sleeve, preferably simultaneously. This configuration has the advantage of requiring fewer separate parts. But it lacks an important feature of the preferred embodiment in that the split disks provide a pathway for dirt to enter the hinge. It is preferred that the hinge have a configuration that is well sealed against the entry of any sort of contaminants from outside the hinge. Dirt that finds its way into a friction hinge causes rapid deterioration of the frictional surfaces causing changes in the frictional torque and erratic behavior.

Another embodiment of our invention is shown in FIG. 9 in which housing 43 has a plurality of axial ridges distributed radially along inner surface 44 and serve the same function as the disks in the previously discussed embodiments. The inside diameter of the peaks of these ridges is smaller than the outside diameter of shaft 47 so that when the shaft is forced into the housing, the peaks are plastically distorted to produce frictional contact with the shaft. The diametrical frictional interference might be perhaps as much as 10 to 12 thousandths of an inch or even more, depending upon the torque requirement. Shaft 47 has adapter 49 irrotatably connected thereto for whatever external attachment is required by the application.

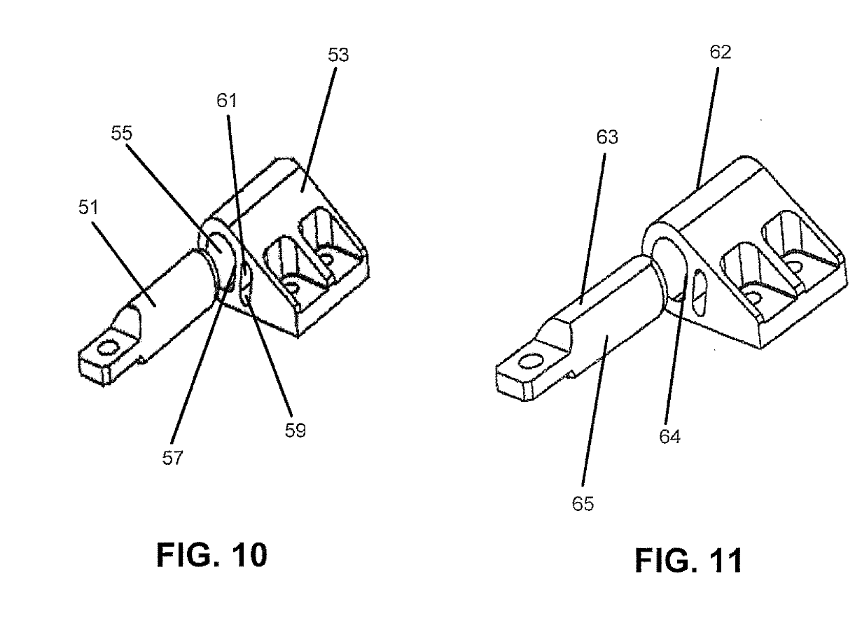

FIG. 10 portrays another embodiment of the invention. In this embodiment, shaft is a plain cylindrical metal shaft. Housing 53 is a molded plastic housing of the same material as the frictional member of the previous embodiments. A hole 55 in the housing is generally of the same diameter as the outside diameter of shaft 51 except that one side of hole 55 has flat area 57 which forms a chord across otherwise circular hole 55. The housing is further formed with a void 59 positioned adjacent to the flat area 57. When shaft 51 is forced into hole 55, the beam formed between hole 55 and void 59 deflects to cause frictional contact with shaft 55. The detail design of this area of the housing can be adjusted to produce a wide range of torques as desired. In addition, it is possible to increase the pressure exerted by beam 1 on shaft 55 by inserting a small piece of urethane rubber into void 59.

In the embodiment of FIG. 11, housing 62 is similar to the housing of FIG. 10 but shaft 65 is provided with a flat surface 63. This surface defines a detent position for the hinge when surface 63 is aligned with the flat area 64. Obviously, more than one such detent position can be created by adding addition flat surfaces similar to surfaces 63.

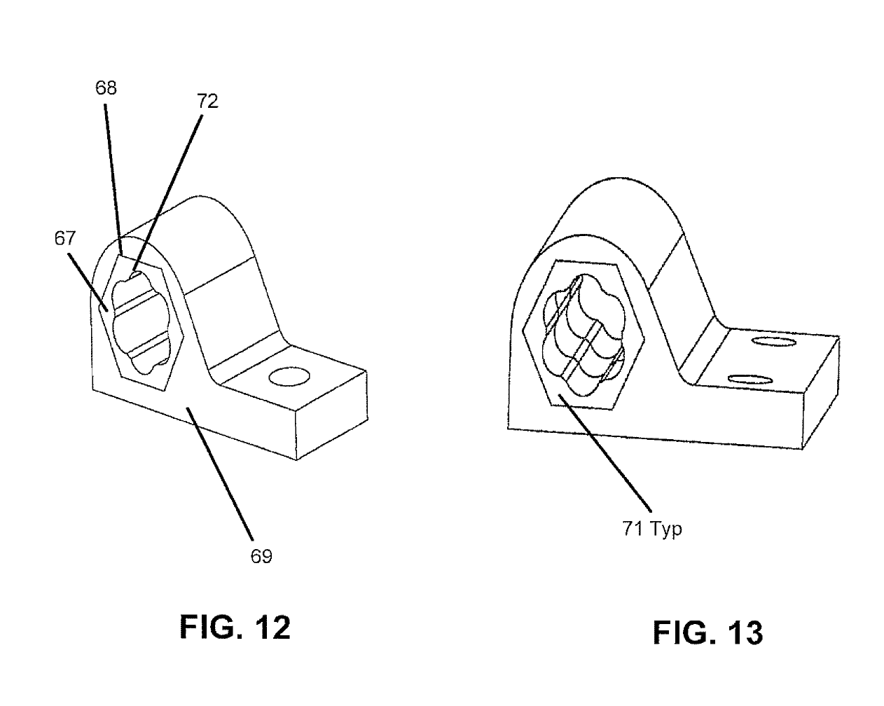

FIG. 12 shows yet another configuration for the hinge of FIG. 9. In this embodiment, the housing 69 can be made of a plastic or metal material and is formed with a hole 68 having a non-circular cross-section. A plastic part 67 has an outer surface matching the shape and size of the hole 68 and an inner surface formed with longitudinal ribs 72 similar to ribs 44. The part 67 is inserted into the hole 68 and is maintained in place by an interference fit or by an adhesive. When the shaft (similar to shaft 47) is inserted into the part 67, the ribs 72 are distorted and form an interference fit with the shaft. This enables a free choice of material for housing 69 which is sometimes important for considerations of strength. The insert 67 is made of a plastic material as discussed above.

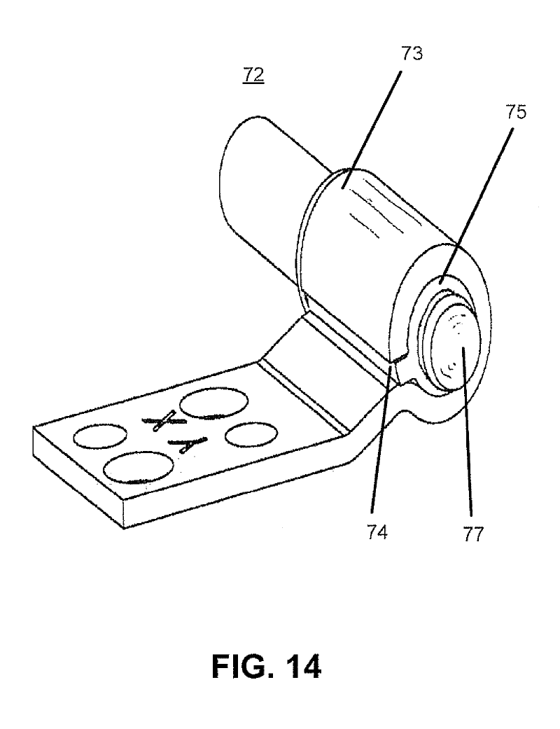

In FIG. 13, a similar arrangement for the plastic part is presented to the arrangement of FIG. 12. In this case, the plastic material is in the form of disks 71 so that the number of such disks can be varied to achieve a range of torques.

FIG. 14 depicts still another method for achieving frictional torque by producing pressure between a plastic part and an internal metal shaft. Quite often, when hinge size is an issue, it is difficult to use a plastic housing capable of withstanding sufficient hoop stress for the needed torque. In this case the hinge 72 is formed of a housing 73 formed of a steel band shaped like a question mark with a slot 74. A plastic frictional member 75 is inserted into the housing 73 and it has an external rib 74 extending into the slot 74 to insure that the element 75 does not rotate with respect to the housing 74. The element 75 is formed with internal features (not shown) similar to any of the embodiments shown in FIGS. 1-13 that provide a frictional engagement with a shaft 77. Any tendency for the plastic bushing to creep and become larger due to the hoop stress is eliminated by the steel band forming housing 73.

In the embodiments described above the housing and the shaft are made of steel, unless otherwise noted. The frictional member is made of a solid plastic material. Typical materials that may be used for this purpose are Delrin® or other comparable materials such as Acetal resin materials. Alternatively, the frictional member may be a solid plastic that contains or is infused with a lubricant. Materials of this kind are available for example, from Dupont (e.g., Delrin® 500 CL BK 601). It should be noted that this material is designated as a medium viscosity acetal homopolymer containing a lubricant that is designed for low wear and friction against metals. For example, Dupont recommends using this material in ball bearings. Other similar materials may be used as well.

It will thus be seen that the objects set forth above among those made apparent from the preceding description, are efficiently attained and, since certain changes may be made in the construction of the inventive friction hinge without departing from the spirit and scope of the invention, it is intended that all matter contained in the above description or shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall therebetween.

We claim:

1. A hinge for the rotational engagement of a first part and a second part comprising:
a housing having a housing attachment member for attaching the first part and forming a sleeve;
a steel shaft connectable to the second part and having an outer surface; and
a frictional member secured to said housing made of a homogeneous solid plastic material having an outer surface engaging said housing and an inner surface defining an opening, said material being selected to partially deform when said shaft is received in said opening to form a frictional engagement between said housing and said shaft.

2. The hinge of claim 1 wherein said frictional member is made of a polymer.

3. The hinge of claim 1 wherein prior to the insertion of said shaft, said frictional member has an inner diameter and said shaft has a shaft diameter larger then said inner diameter, and during said insertion, wherein said frictional member is deformed so that its inner surface is expanded to said shaft diameter.

4. The hinge of claim 1 wherein said inner surface includes a substantially cylindrical wall and a plurality of ribs extending radially inwardly of said cylindrical wall.

5. The hinge of claim 1 further comprising antirotational means to prevent rotation of said frictional member with respect to said housing.

6. The hinge of claim 1 wherein said frictional member is generally cylindrical and is formed of a plurality of identical discs stacked coaxially with respect to each other.

7. The hinge of claim 1 wherein said frictional member includes at least two discs arranged coaxially at a spaced distance from each other.

8. The hinge of claim 1 wherein said frictional member and said housing are made from the same material and are integral to form a single unit.

9. The hinge of claim 1 wherein said housing has a noncircular opening and said frictional member is sized and shaped to fit seamlessly into said noncircular opening.

10. The hinge of claim 1 wherein said housing includes a steel band arranged around said frictional member, said steel band being sized and shaped to apply a radially inward force on said frictional member.

11. The hinge of claim 1 wherein said frictional member is infused with a lubricant.

12. A frictional hinge comprising:
a housing forming a cylindrical sleeve;
a shaft having a cylindrical body; and
a frictional member irrotationally mounted in said housing and including a a generally cylindrical opening for receiving said shaft, said frictional member being formed of a solid plastic material, said material being selected to deform between a first configuration in which said frictional member has an inner diameter smaller then the diameter of said shaft and a second configuration in which said frictional member has a diameter equal to the shaft to form with said shaft a frictional engagement that permits rotation between said housing and said shaft only in response to a substantial torque, said frictional engagement causing said rotation to stop immediately after the removal of the torque.

13. The hinge of claim 12 wherein said frictional member is formed with a substantial cylindrical section, a substantially planar section and an opening behind said substantially planar section to receive a portion of plastic caused by the deformation when the shaft is inserted.

14. The hinge of claim 13 wherein said shaft has a straight portion to form a detent with said straight section.

15. The hinge of claim 12 wherein said frictional member is an integral element.

16. The hinge of claim 12 wherein said frictional member is formed of a plurality of disks aligned axially within said sleeve.

17. The hinge of claim 12 wherein said frictional member includes a tab received in said housing to prevent rotation between said housing and said frictional member.

18. The hinge of claim 12 wherein said frictional member is made of a plastic material infused with a lubricant.

19. A method of making a frictional hinge comprising;
providing a housing with sleeve;
providing a shaft having a cylindrical body having a shaft diameter;
providing a frictional member made of a plastic material, said frictional member having a central hole with an inner diameter smaller then the shaft diameter;
forcing said shaft into said central hole to cause a portion of said frictional member to deform about said shaft and form a frictional engagement between said shaft and said frictional member.

20. The method of claim 19 wherein said frictional member is formed with a plurality of ribs extending radially inwardly, and spaces disposed near said ribs, wherein portions of each of said ribs deform and migrate into said spaces.
